(19) United States
(12) Patent Application Publication
(10) Pub. No.: US 2010/0145587 A1
(43) Pub. Date: Jun. 10, 2010

(54) METHOD AND APPARATUS FOR MANAGING TRAFFIC INFORMATION USING LIGHT COMMUNICATION

(76) Inventor: Myunghee SON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/613,078

(22) Filed: Nov. 5, 2009

Related U.S. Application Data
(60) Provisional application No. 61/112,249, filed on Nov. 7, 2008.

(51) Int. Cl. G08G 1/00; G06F 7/00; F02D 45/00

(52) U.S. Cl. 701/70; 701/117; 701/102

(57) ABSTRACT

A traffic information management method and apparatus is provided. The traffic information management method using light communication includes: receiving an optical signal transmitted from a signal system; acquiring traffic information contained in the light signal; and providing the traffic information to a user terminal.

### CROSS-REFERENCE(S) TO RELATED APPLICATIONS

The present application claims priority of U.S. Patent Application No. 61/112,249, filed on Nov. 7, 2008, which is incorporated herein by reference in its entirety.

### BACKGROUND OF THE INVENTION

1. Field of the Invention

Exemplary embodiments of the present invention relate to a traffic information management method and apparatus; and, more particularly, to a traffic information management method and apparatus using light communication.

2. Description of Related Art

Recently, as the communication technology develops rapidly, much research has been conducted on the wireless communication technology. However, since Radio Frequency (RF) resources are limited and various RF technologies using similar bands have appeared, the development of technology capable of complementing the RF technology is being demanded.

Recently, a great deal of attention is being paid to Visible Light Communication (VLC). The VLC is a next generation communication technology which transmits data through light generated by a visible light emitting device. The VLC system transmits digital data through flickering or brightness variation of a visible light emitting device such as a Light Emitting Diode (LED), a Super Luminescent Diode (SLD), or a Laser Diode (LD) which emits a visible wavelength of 400 nm to 700 nm. When the brightness variation of light occurs fifty times or more for one second, people do not perceive the flickering, but recognize that the light source is continuously turned on. Therefore, while performing its own function as a light source, the VLC system may transmit desired data.

### SUMMARY OF THE INVENTION

An embodiment of the present invention is directed to a traffic information management method and apparatus using light communication, which provides a variety of information to a vehicle such that a vehicle may drive the vehicle economically.

Another embodiment of the present invention is directed to a traffic information management method and apparatus using light communication, which may provide a vehicle driver or pedestrian with a variety of useful information containing signal duration and so on.

Another embodiment of the present invention is directed to a traffic information management method and apparatus, which may make the most of an existing infrastructure without additional equipments to perform information exchange between the infrastructure and a vehicle or a pedestrian.

In accordance with an embodiment of the present invention, a traffic information management method using light communication includes: receiving an optical signal transmitted from a signal system; acquiring traffic information contained in the light signal; and providing the traffic information to a user terminal.

In accordance with another embodiment of the present invention, a traffic information management apparatus using light communication includes: a reception unit configured to receive an optical signal transmitted from a signal system; a control unit configured to acquire traffic information contained in the optical signal; and a transmission unit configured to provide the traffic information to a user terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a configuration diagram of a traffic information management apparatus in accordance with an embodiment of the present invention.

FIG. 2 is a diagram explaining a traffic information management method in accordance with another embodiment of the present invention.

FIG. 3 is a diagram explaining a traffic information management method in accordance with another embodiment of the present invention.

FIG. 4 is a flow chart explaining the traffic information management method in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Embodiments of the present invention provide a traffic information management method and apparatus which provides useful information to a driver or a pedestrian through light communication, or particularly visible light communication (VLC), and controls a vehicle using the provided information such that the driver may drive more economically and safely.

In the embodiments of the present invention, a signal system transmits a light signal, and the transmitted signal is received by terminals of users. Representative examples of the signal system may include traffic lights installed on the road. In general, the traffic light includes a stop signal (red), a preliminary signal (yellow), a go-ahead signal (green). When a light source of the traffic light is implemented as a visible light emitting device such as a Light Emitting Diode (LED), the traffic light may transmit the respective signals with desired data. In the embodiments of the present invention, data contained in an optical signal is referred to as “traffic information”. The traffic information may include information on the type of each signal, duration information of the signal, positional information, multimedia information, and other information required for controlling and driving a vehicle.

User terminals receiving optical signals may be implemented in various types. For example, mobile phones or potable devices of pedestrians, navigation systems or black boxes of vehicles, and so on may be used as the user terminals.

In an embodiment of the present invention, a traffic information management apparatus inside a vehicle receiving an optical signal from a signal system generates vehicle control information using traffic information contained in the optical signal. The “vehicle control information” may include not only information for controlling vehicles directly and indirectly, but also overall information which may help drivers to control vehicles. Therefore, such vehicle control information makes it possible to provide an Idle Stop & Go (ISG) technology, information on whether to accelerate or stop in a dilemma zone, and economical speed information for economical driving.

In another embodiment of the present invention, pedestrians using a crosswalk may receive useful information through terminals capable of performing light communication with a signal system. The pedestrians may catch how long a current signal (stop or pedestrian signal) will continue, through traffic information contained in an optical signal transmitted from the signal system, and then come to a stop or quicken their pace. Furthermore, the pedestrians may receive positional information around the signal system, for example, information on restaurants or places of interest and a variety of multimedia information such as music and motion pictures. Such a variety of information useful for pedestrians may be provided in consideration of ages, sexes, and physical disabilities of the pedestrians.

Hereafter, the traffic information management method and apparatus in accordance with embodiments of the present invention will be described in details.

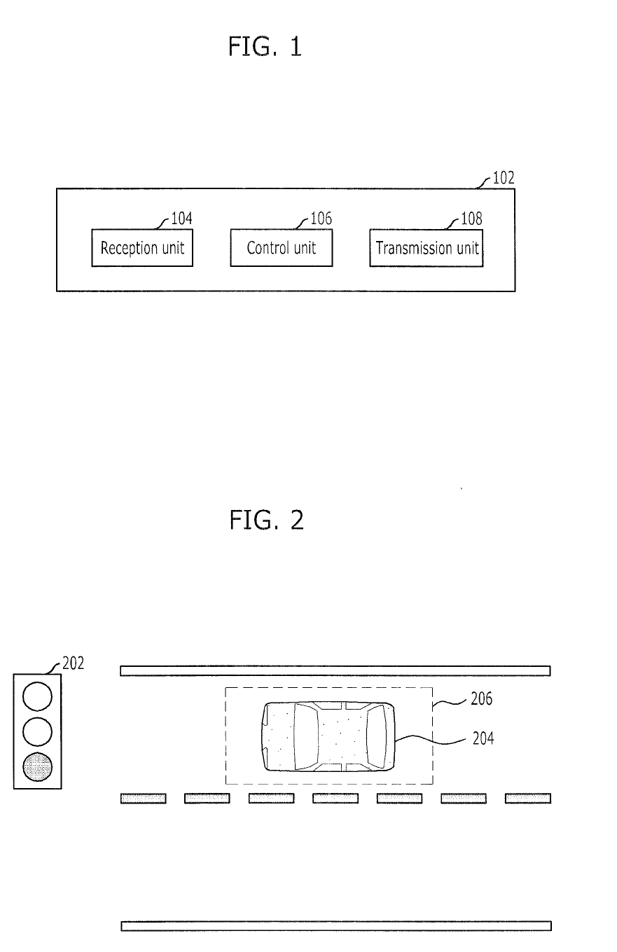

FIG. 1 is a configuration diagram of a traffic information management apparatus in accordance with an embodiment of the present invention.

Referring to FIG. 1, the traffic information management apparatus 102 in accordance with the embodiment of the present invention includes a reception unit 104, a control unit 106, and a transmission unit 108.

The reception unit 104 serves to receive an optical signal transmitted from a signal system. Examples of the reception unit 104 may include a camera sensor mounted on a mobile phone or the front of a vehicle, an optical device built in a navigation system, and so on.

The control unit 106 serves to acquire traffic information contained in the optical signal received by the receiving unit 104. Furthermore, the control unit 106 generates vehicle control information using the acquired traffic information. The process of generating vehicle control information and contents contained in the vehicle control information generated through the process may differ depending on embodiments of the present invention. This will be described below.

The transmission unit 108 serves to provide the traffic information acquired by the control unit 106 to a user terminal. Furthermore, the transmission unit 108 serves to provide the vehicle control information generated by the control unit 106 to a vehicle.

The traffic information management apparatus 102 may be a separate device installed in the front of a vehicle, or may be installed as a partial module of another device such as a black box or navigation system of the vehicle.

FIG. 2 is a diagram explaining a traffic information management method in accordance with another embodiment of the present invention.

In FIG. 2, a general three-color (red, yellow, and green) traffic light is used as a signal system 202. In another embodiment of the present invention, however, a different traffic light to which a signal other than the three-color signals is added may be used. A signal system having quite a different form from a general traffic light may be used.

In FIG. 2, the signal system 202 basically serves as a traffic light, that is, serves to control the stop or travel of a vehicle 204 on a road. Furthermore, the signal system 202 implemented as a visible light emitting device such as an LED emits visible light with traffic information. The traffic information means a variety of information required for controlling and driving a vehicle. For example, the traffic information may include the type of a corresponding signal, the duration of the corresponding signal, the traffic volume of a current position, the speed of the vehicle, and so on.

First, when the signal system 202 displays a go-ahead signal (green), the traffic information management apparatus of the vehicle 204 traveling on the road receives green visible light through the reception unit. Then, the traffic information management apparatus acquires the traffic information contained in the green visible light, and generates vehicle control information using the traffic information. This vehicle control information may include a current traveling speed of the vehicle 204, which is measured by the signal system 202 or the vehicle 204, and economical speed information which is calculated in consideration of a variety of information contained in the traffic information. The traffic information management apparatus delivers the vehicle control information containing the economical speed information to the vehicle 204, and may suggest the economical speed for economical driving to a driver through a display of a navigation system or the like. In addition, a variety of information contained in the traffic information also may be delivered to the driver with the vehicle control information.

When the signal system 202 displays a stop signal (red), the vehicle 204 stops. The ISG technology refers to a technology which stops an engine of a vehicle to save fuel consumed while the engine is in an idle state, and then restarts the engine when the vehicle starts traveling. In accordance with the embodiment of the present invention, the efficiency of the ISG technology may be increased by the VLC between the signal system 202 and the vehicle 204.

The traffic information management apparatus of the vehicle 204 receiving the red visible light transmitted from the signal system 202 acquires duration information of the stop signal, which is contained in the red visible light. As the traffic information management apparatus acquires the duration information of the stop signal, the traffic information management apparatus may catch how long the red signal will continue, and thus properly calculate how long the vehicle is to stop an engine. Using the duration information of the stop signal, the traffic information management apparatus generates vehicle control information containing an engine control command. The engine control command may be a command for directly stopping an engine and restarting the engine or a command for indirectly informing the stop and start of the engine. Using the vehicle control information containing the engine control command delivered in such a manner, the vehicle 204 stops the engine while the stop signal is maintained, and restarts the engine to start traveling. Therefore, fuel may be saved. In addition, the vehicle control information may include a variety of information during the go-ahead signal when provided to drivers.

Between the go-ahead signal (green) and the stop signal (red), a preliminary signal (yellow) exists to inform a signal change. When the signal system 202 displays the preliminary signal when the vehicle 204 is traveling, the driving pattern of the driver may be divided into two patterns. One pattern is to travel more quickly by accelerating the vehicle before the signal changes to the stop signal, and the other pattern is stop the vehicle by reducing speed. Such an interval at which the driver hesitates to accelerate or stop the vehicle 204 during the preliminary signal is referred to as a dilemma zone 206. Excessive acceleration in the dilemma zone 206 may lead to a high traffic accident rate at an intersection.

The traffic information management method in accordance with the embodiment of the present invention may assist the decision of the driver in the dilemma zone, thereby reducing the accident rate. The traffic information management apparatus of the traveling vehicle 204 receives the preliminary signal, that is, yellow visible light. The traffic information management apparatus recognizes that the current signal is the preliminary signal, from traffic information contained in the yellow visible light, and then determines whether to accelerate or stop the vehicle 204, based on the information contained in the traffic information and information acquired from the vehicle 204. An algorithm of determining whether to accelerate or stop the vehicle 204 may be implemented in various manners depending on embodiments. For example, the traffic information management apparatus may determine whether to accelerate or stop the vehicle 204 by collectively considering a variety of information such as the duration of the current preliminary signal, the speed of the vehicle, and a distance between the signal system and the vehicle.

When the acceleration or stop of the vehicle 204 is determined, the traffic information management apparatus generates vehicle control information containing an acceleration command or stop command depending on the determination result, and delivers the generated vehicle control information to the vehicle 204. The acceleration command or stop command may be a command for directly or indirectly accelerating or stopping the engine or information for simply informing the driver that it is desirable to stop the vehicle 204. For example, when determining that it is desirable to stop the vehicle 204, the traffic information management apparatus may deliver vehicle control information containing a stop command to the vehicle 204, and the vehicle 204 may reduce speed gradually using the vehicle control information. In another embodiment of the present invention, the vehicle 204 receiving vehicle control information containing a stop command may display information through a display of a navigation system or the like, the information suggesting that a vehicle driver should reduce speed. In addition, the vehicle control information may include a variety of information during the go-ahead signal when provided to the driver.

The traffic information management method in accordance with the embodiment of the present invention may provide useful information to drivers and vehicles through optical signals such that economical driving is performed. Furthermore, the traffic information management method may help drivers to drive vehicles safely through the provided traffic information, thereby contributing to reducing an accident rate.

Recently, a black box installed in each vehicle helps to analyze an accident cause of the vehicle. In accordance with the traffic information management method of the embodiment of the present invention, the information recorded in the black box and the traffic information received from the signal system may be collectively considered to analyze the accident cause more clearly.

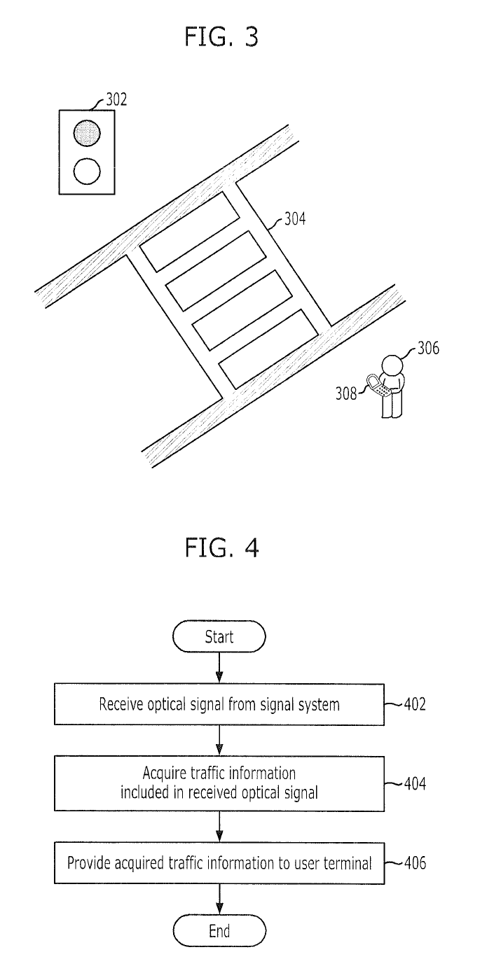

FIG. 3 is a diagram explaining a traffic information management method in accordance with another embodiment of the present invention.

In FIG. 3, a general two-color (red and green) traffic light 302 is used. In another embodiment of the present invention, however, a different traffic light to which a signal other than the two-color signals is added may be used. A signal system having quite a different form from a general traffic light may be used.

In FIG. 3, the signal system 302 basically serves as a traffic light, that is, serves to instruct a pedestrian 306 to take a crosswalk 304 or wait at the crosswalk 304. The signal system 302 implemented as a visible light emitting device such as an LED emits visible light with traffic information. The traffic information means a variety of information useful for the pedestrian 306. For example, the traffic information may include the type of a corresponding signal, the duration of the corresponding signal, positional information around the signal system, multimedia information, and so on.

When the signal system 302 displays a stop signal (red), the pedestrian 306 waits for a pedestrian signal (green) at the crosswalk 304. At this time, a terminal 308 of the pedestrian 306 receives red visible light transmitted from the signal system 302. This red visible light includes the above-described traffic information. The terminal 308 may catch the type (stop signal) of the current signal through the traffic information contained in the received red visible light, and then display how long the signal will continue. Therefore, the pedestrian 306 may catch how long he/she should wait, through the display of the terminal 308.

When the signal system 302 displays the pedestrian signal (green) while the pedestrian 306 stops or moves, the terminal 308 receives green visible light transmitted from the signal system 302. The terminal 308 may calculate how long the pedestrian signal will continue, through the traffic information contained in the green visible light, and then display the result on the display. Therefore, the pedestrian 306 may cross the crosswalk 304 before the pedestrian signal changes to the stop signal. Such a function may help the pedestrian 306 to cross safely, contributing to reducing an accident rate of the pedestrian 306.

As described above, the traffic information contained in the light signal transmitted by the signal system 302 may include positional information around the signal system, multimedia information, and so on. Therefore, the pedestrian 306 may obtain information on buildings and public transportations around the current position through the terminal 308. Using such a function, the terminal 308 may provide the pedestrian an additional service such as showing the way. Furthermore, the terminal 308 may provide the pedestrian 306 with a variety of multimedia information such as music and motion pictures contained in the traffic information. Such useful information may be processed depending on the age, the sex, or the physical disability of the pedestrian 306, and then provided to the pedestrian 306 through the terminal 308.

FIG. 4 is a flow chart explaining the traffic information management method in accordance with the embodiment of the present invention.

The traffic information management apparatus receives an optical signal transmitted from a signal system at a step S402. In this case, visible light may be used as the optical signal, and the signal system may be implemented as a visible light emitting device for transmitting visible light.

The traffic information management apparatus receiving the optical signal acquires traffic information contained in the optical signal at a step S404. The traffic information may include a variety of information required for a pedestrian, a driver, or a vehicle. The traffic information management apparatus provides the acquired traffic information to a user terminal at a step S406. Examples of the user terminal may include mobile phones of pedestrians or drivers, navigation systems or black boxes of vehicles, and separate devices.

In accordance with another embodiment of the present invention, a traffic information management apparatus may generate vehicle control information using acquired traffic information. The vehicle control information may be generated in a different manner depending on the types of optical signals, information contained in the traffic information, and other traffic situations. The traffic information management apparatus provides the generated vehicle control information to a vehicle.

In accordance with the embodiments of the present invention, the light communication is used to provide a variety of information to vehicles such that economical driving may be performed.

Furthermore, the light communication is used to provide vehicle drivers or pedestrians with a variety of information containing the signal duration and so on.

Furthermore, the method and apparatus may make the most of an existing infrastructure without additional equipments to perform information exchange between the infrastructure and a vehicle or a pedestrian.

While the present invention has been described with respect to the specific embodiments, it will be apparent to those skilled in the art that various changes and modifications may be made without departing from the spirit and scope of the invention as defined in the following claims.

What is claimed is:

1. A traffic information management method using light communication, comprising:
receiving an optical signal transmitted from a signal system;
acquiring traffic information contained in the light signal; and
providing the traffic information to a user terminal.

2. The traffic information management method of claim 1, further comprising:
generating vehicle control information using the traffic information; and
providing the vehicle control information to a vehicle.

3. The traffic information management method of claim 2, wherein the vehicle control information comprises economical speed information for economical driving of the vehicle.

4. The traffic information management method of claim 2, wherein said generating vehicle control information using the traffic information comprises:
when the optical signal is a stop signal, acquiring duration information of the stop signal contained in the traffic information; and
generating the vehicle control information containing an engine control command by using the duration information of the stop signal.

5. The traffic information management method of claim 2, wherein said generating vehicle control information using the traffic information comprises:
when the optical signal is a preliminary signal, determining whether to accelerate or stop the vehicle; and
generating the vehicle control information containing an acceleration command or stop command, depending on the result of said determining whether to accelerate or stop the vehicle.

6. A traffic information management apparatus using light communication, comprising:
a reception unit configured to receive an optical signal transmitted from a signal system;
a control unit configured to acquire traffic information contained in the optical signal; and
a transmission unit configured to provide the traffic information to a user terminal.

7. The traffic information management apparatus of claim 6, wherein the control unit generates vehicle control information using the traffic information, and the reception unit provides the vehicle control information to a vehicle.

8. The traffic information management apparatus of claim 7, wherein the vehicle control information comprises economical speed information for economical driving of the vehicle.

9. The traffic information management apparatus of claim 7, wherein the control unit acquires duration information of the stop signal contained in the traffic information when the optical signal is a stop signal, and generates vehicle control information containing an engine control command by using the duration information of the stop signal.

10. The traffic information management apparatus of claim 7, wherein the control unit determines whether to accelerate or stop the vehicle when the optical signal is a preliminary signal, and generates vehicle control information containing an acceleration command or stop command depending on the determination result.
